(19) United States
(12) Patent Application Publication
(10) Pub. No.: US 2025/0227424 A1
(43) Pub. Date: Jul. 10, 2025

(54) RENDERING OF AN M-CHANNEL INPUT ON S SPEAKERS (S<M)

(71) Applicant: Dolby Laboratories Licensing Corporation, San Francisco, CA (US)

(72) Inventors: Ziyu Yang, Beijing (CN); Zhiwei Shuang, Beijing (CN); Yang Liu, Beijing (CN); Zhifang Liu, Beijing (CN)

(73) Assignee: Dolby Laboratories Licensing Corporation, San Francisco, CA (US)

(21) Appl. No.: 17/621,193

(22) PCT Filed: Jun. 17, 2020
(86) PCT No.: PCT/US2020/038209

§ 371 Date: Dec. 20, 2021

Related U.S. Application Data
(60) Provisional application No. 62/875,160, filed on Jul. 17, 2019.

(30) Foreign Application Priority Data
Jun. 20, 2019 (WO) PCT/CN2019/092021

(51) Int. Cl. H04S 3/00; H04S 7/00

(52) U.S. Cl. CPC H04S 3/008; H04S 7/30; H04S 2400/03

(57) ABSTRACT

An audio renderer for rendering a multi-channel audio signal having M channels to a portable device having S independent speakers, comprising a first matrix application module for applying a primary rendering matrix to the input audio signal to provide a first pre-rendered signal suitable for playback on the multiple independent speakers, a second matrix application module for applying a secondary rendering matrix to the input audio signal to provide a second pre-rendered signal suitable for playback on the multiple independent speakers, a channel analysis module configured to calculate mixing gain according to a time-varying channel distribution, and a mixing module configured to produce a rendered output signal by mixing the first and second pre-rendered signals based on the mixing gain.

### CROSS-REFERENCE TO RELATED APPLICATIONS

This application claims priority to PCT Application Serial No. PCT/CN2019/092021, filed on Jun. 20, 2019 and U.S. Provisional Application Ser. No. 62/875,160, filed on Jul. 17, 2019, each of which is hereby incorporated by reference in its entirety.

### FIELD OF THE INVENTION

The present invention relates to rendering of an M-channel input on S speakers, when S is less than M.

### BACKGROUND OF THE INVENTION

Portable devices such as cell-phones and tablets have become increasingly popular and are now very common. They are frequently used for media playback including movies and music, e.g. from YouTube or similar sources. In order to achieve an immersive listening experience, portable devices are often equipped with multiple independent speakers. For example, a tablet may be equipped with two top-layer speakers and two bottom-layer speakers. Further, the devices are usually equipped with multiple independent power amplifiers (PAs) for the speakers, to make the device flexible for playback control.

At the same time, multichannel audio content, i.e. content with more than two channels, e.g., 5.1, 5.1.2, is becoming more common. The multichannel audio can be either originally produced or converted from other formats, e.g., object-based audio or by various up-mixing methods.

There are different approaches to rendering multichannel audio to portable devices having fewer speakers than the number of channels. One approach to rendering a 5.1.2 audio signal (eight channels) to a four-speaker tablet is to render the height channels of input signal to the two top-layer speakers. To keep the playback sound balanced in terms of top-layer speakers and bottom-layer speakers, the direct channels (i.e., the non-height channels) are rendered to the two bottom-layer speakers. One example of such a rendering approach is provided by

However, prior art rendering approaches have not taken the time-varying behavior of the input audio channels into account.

### GENERAL DISCLOSURE OF THE INVENTION

It is an object of the present invention to provide a more dynamic rendering approach based on the input audio.

According to a first aspect of the present invention, this and other objects are achieved by an audio renderer for rendering a multi-channel audio signal having a number M of channels to a portable device having a number S of independent speakers, wherein S<M, comprising a first matrix application module for applying a primary rendering matrix to the input audio signal to provide a first pre-rendered signal suitable for playback on the multiple independent speakers, a second matrix application module for applying a secondary rendering matrix to the input audio signal to provide a second pre-rendered signal suitable for playback on the multiple independent speakers, a channel analysis module configured to calculate mixing gain according to a time-varying channel distribution, and a mixing module configured to produce a rendered output signal by mixing the first and second pre-rendered signals based on the mixing gain.

According to a second aspect of the present invention, this and other objects are achieved by a method for rendering a multi-channel audio signal having a number M of channels to a portable device having a number S of independent speakers, wherein S<M, comprising applying a primary rendering matrix to the input audio signal to provide a first pre-rendered signal suitable for playback on the multiple independent speakers, applying a secondary rendering matrix to the input audio signal to provide a second pre-rendered signal suitable for playback on the multiple independent speakers, calculating mixing gain according to a time-varying channel distribution, and mixing the first and second pre-rendered signals based on the mixing gain to produce a rendered output signal.

The invention is based on the realization that a multichannel audio input may have a varying number of active channels. By providing several (at least two) different rendering matrices, and selecting an appropriate mix of rendering matrices based on an analysis of the input signal, a more efficient rendering on the available speakers can be achieved.

In extreme cases, the rendered output will correspond to one of the pre-rendered signals, in other cases it will be a mix of both.

The secondary rendering matrix can be configured to ignore at least one of the channels in the input audio format. This may be appropriate when one or several channels of the input signal are relatively weak, and thus no longer significantly contribute to the rendered output. One example of channels that may be weak during periods of time, are height channels, i.e. channels intended for playback on (height) speakers located above the listener, or at least higher than the other (direct) speakers.

A specific example relates to 5.1.2 audio, i.e. audio having left, right, center, left rear, right rear, LFE, and left/right height channels. During some periods, for example the height channels may be relatively weak, in which case the 5.1.2 signal degenerates to a 5.1 signal, i.e. six channels instead of eight. In that situation, the original rendering matrix (adapted for 5.1.2) may lead to the unbalanced loudness between top-level and bottom-level speakers. According to the present invention, the rendering may be dynamically adjusted to focus on the currently active channels. So, in the given example, the input audio can be rendered using a rendering matrix adapted for 5.1 instead of a rendering matrix adapted for 5.1.2. The following detailed description will provide more detailed examples of rendering matrices.

### BRIEF DESCRIPTION OF THE DRAWINGS

The present invention will be described in more detail with reference to the appended drawings, showing currently preferred embodiments of the invention.

FIG. 1 is a block diagram of an audio renderer according to an embodiment of the present invention.

FIG. 2 is a flow chart of an embodiment of the present invention.

FIG. 3a-b show two examples of four-speaker layouts of a portable device landscape orientation, corresponding to up/down firing (FIG. 3a) and left/right firing (FIG. 3b).

### DETAILED DESCRIPTION OF CURRENTLY PREFERRED EMBODIMENTS

Systems and methods disclosed in the following may be implemented as software, firmware, hardware or a combination thereof. In a hardware implementation, the division of tasks does not necessarily correspond to the division into physical units; to the contrary, one physical component may have multiple functionalities, and one task may be carried out by several physical components in cooperation. Certain components or all components may be implemented as software executed by a digital signal processor or microprocessor, or be implemented as hardware or as an application-specific integrated circuit. Such software may be distributed on computer readable media, which may comprise computer storage media (or non-transitory media) and communication media (or transitory media). As is well known to a person skilled in the art, the term computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Further, it is well known to the skilled person that communication media typically embodies computer readable instructions, data structures, program modules or other data in a modulated data signal such as a carrier wave or other transport mechanism and includes any information delivery media.

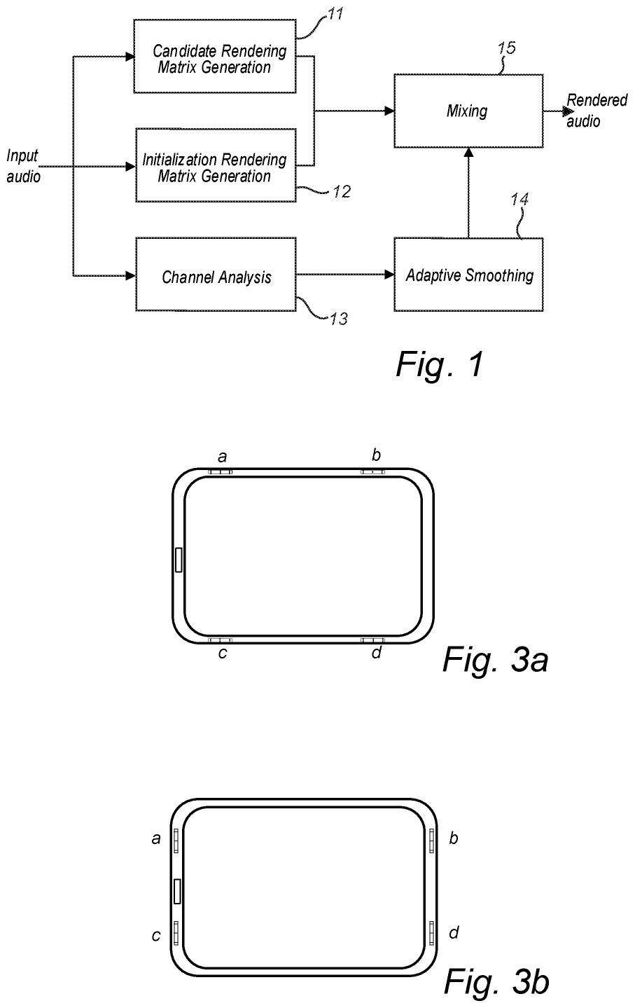

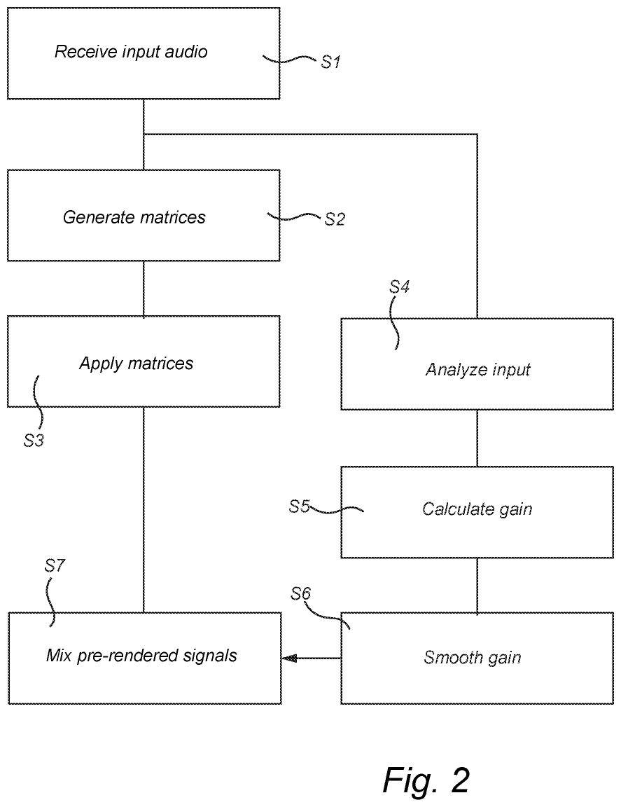

An embodiment of the present invention will now be discussed with reference to the block diagram in FIG. 1, and the flow chart in FIG. 2.

The method is executed in a real-time manner. Initially, a multi-channel input audio is received (e.g. decoded) in step S1, and a set of rendering matrices are generated in step S2 based on the number M of received channels and number S of available speakers. Each rendering matrix is configured to render M received signals into S speaker feeds, where S<M. In the illustrated example, the set includes an primary (default) matrix and a secondary (alternative) matrix, but one or several additional alternative matrices are possible. In step S3, each matrix is applied to the input signal by matrix application modules 11, 12 to generate pre-rendered signals for further mixing. In a parallel step S4, the input audio is analyzed by a channel analysis module 13. In step S5, a gain is calculated by the analysis module 13, e.g. based on the energy distribution among channels. This gain is further smoothed by a smoothing module 14 in step S6, and then input to a mixing module 15, which also receives the output from the matrix application modules 11, 12. In step S7, the mixing module 15 mixes (weighs) the pre-rendered signals based on the smoothed gain, and outputs a rendered audio signal. Details of the rendering process will be discussed in the following.

### Rendering Matrixes

Given an M-channel input signal and a S-speaker device, the general rendering process can be represented as the equation below:

$$y = R x \qquad ( 1 )$$

where x is a M-dimensional vector denoting the input signal, y is a S-dimensional vector denoting the rendered signal, R is a S×M rendering matrix. For the rendering matrix R, the rows correspond to the speakers, while columns correspond to the channels of input signal. The entries of the rendering matrix indicate the mapping from channels to speakers.

Given a portable device with S independent speakers (S >2), and primary rendering matrix Rₚᵣᵢₘ and the secondary rendering matrix R_{sec} will be determined according to the number of input channels M. Both the Rₚᵣᵢₘ and R_{sec} have the same size S×M. Specifically, the matrixes Rₚᵣᵢₘ and R_{sec} can be written as

$${R}_{prim} {=}^{Δ} [ \begin{matrix}{a}_{1 , 1} & … & {a}_{1 , M} \\ ⋮ & ⋱ & ⋮ \\ {a}_{S , 1} & … & {a}_{S , M}\end{matrix} ] \qquad ( 2 )$$

$${R}_{sec} {=}^{Δ} [ \begin{matrix}{b}_{1 , 1} & … & {b}_{1 , M} \\ ⋮ & ⋱ & ⋮ \\ {b}_{S , 1} & … & {b}_{S , M}\end{matrix} ] \qquad ( 3 )$$

where, the Rₚᵣᵢₘ is the optimal matrix for rendering the input M-channel audio, while the R_{sec} is the optimal matrix for a degenerated signal, i.e. an M-channel audio signal including only D relevant channels (D<M) and one or several channels which have an insignificant contribution and may be ignored. The rendering matrix R_{sec} is thus also an S×M matrix, but has one or several zero columns (a zero column will result in zero contribution from one of the M channels). When the two rendering matrixes Rₚᵣᵢₘ and R_{sec} are applied to the input signal x, two pre-rendered signals yₚᵣᵢₘ and y_{sec}, are generated:

$${y}_{p r i m} = {R}_{p r i m} x \qquad ( 4 )$$

$${y}_{sec} = {R}_{sec} x \qquad ( 5 )$$

In general, a multichannel audio usually comprise four categories of channels:
1) Front channels, i.e., Left, Right, and Center channel (L, R, C)
2) Listener-plane surround channels, e.g., Left/Right Surround (Ls/Rs) of 5.1/5.1.2/5.1.4 etc., or Left/Right Rear Surround (Lrs/Rrs) of 7.1/7.1.2/7.1.4 etc.
3) Height channels, e.g., Left/Right Top (Lt/Rt) of 5.1.2/7.1.2/9.1.2 etc., Left/Right Top Front/Rear (Ltf/Rtf, Ltr/Rtr) of 5.1.4/7.1.4/9.1.4, etc.
4) LFE channel.

Given the target speaker layout, the primary matrix defined in equation (2) can be re-written as a blocking matrix:

$${R}_{prim} {=}^{Δ} [ \text{} \begin{matrix}{a}_{1 , 1} & … & {a}_{1 , M} \\ ⋮ & ⋱ & ⋮ \\ {a}_{S , 1} & … & {a}_{S , M}\end{matrix} ] = [ \text{} \begin{matrix}{f}_{1 , 1} & … & {f}_{1 , F} \vert {r}_{1 , 1} & … & {r}_{1 , R} \vert {l}_{1} \vert {h}_{1 , 1} & … & {h}_{1 , H} \\ ⋮ & ⋱ & \vert ⋮ \vert & ⋱ & ⋮ \vert ⋮ \vert ⋮ & ⋱ & ⋮ \\ {f}_{S , 1} & … & {f}_{S , F} \vert {r}_{S , 1} & … & {r}_{S , R} \vert {l}_{S} \vert {h}_{S , 1} & … & {h}_{S , H}\end{matrix} \text{} ] \qquad ( 6 )$$

where F, R, and H are the number of front, surround and height channels respectively, and lᵢ correspond to the coefficients of LFE.

The secondary matrixes R_{sec} can be derived from Rₚᵣᵢₘ with one or more zero columns.

Some more specific examples of rendering matrices according to embodiments of the present invention will be discussed in the following.

FIGS. 3a and 3b illustrate two examples of a portable device, here a tablet in landscape orientation, which device is equipped with a plurality of independently controlled loudspeakers. In both examples the device has four speakers a-d (S=4). In FIG. 1a, the speakers are arranged on the upper and lower sides of the device, and thus include two speakers a, b emitting sound upwards, and two speakers c, d emitting sound downwards. In FIG. 1b, the speakers are arranged on the left and right sides of the device, and thus include two upper speakers a, b emitting sound sideways, and two lower speakers c, d also emitting sound sideways.

In the present example, a 5.1.2-channel audio signal (M=8) is played back on the portable device in FIG. 3a or 3b.

In this case, the primary matrix Rₚᵣᵢₘ can be defined by

$${R}_{p r i m} = [ \text{} \begin{matrix}{a}_{1 , 1} & … & {a}_{1 , 8} \\ ⋮ & ⋱ & ⋮ \\ {a}_{4 , 1} & … & {a}_{4 , 8}\end{matrix} ] \qquad ( 7 )$$

where the row index 1 to 4 corresponds to speaker a to d respectively, and column index 1 to 8 corresponds to L, R, C, Ls, Rs, LFE, Lt, Rt channel of 5.1.2 format.

During a period when the height channels of the original 5.1.2 signal are approximately silent, the audio signal degenerates to a 5.1 signal plus two channels which may be ignored. Therefore, the secondary rendering matrix R_{sec1} can be defined by

$${R}_{s e c 1} = [ \begin{matrix}{b}_{1 , 1} & … & {b}_{1 , 6} \vert 0 & 0 \\ ⋮ & ⋱ & \vert ⋮ \vert & ⋮ \\ {b}_{4 , 1} & … & {b}_{4 , 6} \vert 0 & 0\end{matrix} ] \qquad ( 8 )$$

where the last two columns are zeros which corresponds to the two silent height channels Lt and Rt.

It should be noted that there can be multiple secondary rendering matrices R_{secX} for a given device and an input signal. In the above example of rendering 5.1.2 audio to four speakers, if the surround channels Ls, Rs also are approximately silent, in addition to the height channels, the signal degenerates to a 3.1 signal only containing the C, L, R and LFE channels, and a set of channels that may be ignored. In that case, a corresponding secondary matrix R_{secZ} becomes

$${R}_{sec 2} = [ \begin{matrix}{b}_{1 , 1} & … & {b}_{1 , 4} \vert 0 & 0 \vert 0 & 0 \\ ⋮ & ⋱ & \vert ⋮ \vert & \vert ⋮ \vert & ⋮ \\ {b}_{4 , 1} & … & {b}_{4 , 4} \vert 0 & 0 \vert 0 & 0\end{matrix} ] \qquad ( 9 )$$

In practice, if there are multiple secondary matrixes, the proper secondary matrix will be chosen dynamically based on the channel analysis described below.

In addition to ensuring efficient rendering of the input signal, there is also a challenge to ensure that all input channels (e.g. height channels) are clearly distinguishable after rendering. This is due to the small distances between speaker locations in a portable device. Taking the example of height channels, they are likely to be rendered to speakers that are relatively close to the speakers for non-height channels. This will lead to spatial collapse in terms of height sound image.

In order to alleviate the spatial collapse and to make height channels distinguishable after rendering, it is critical to generate the proper entries of rendering matrix Rₚᵣᵢₘ. Specifically, it is desirable to render the majority of height channels to top speakers while rendering front channels to the bottom speakers. This will alleviate the height channels “sinking into” the front channels.

For the example mentioned above, the entries of Rₚᵣᵢₘ can be set to

$${R}_{prim} = [ \begin{matrix}0 & 0 & 0.5 & 0 & 0.5 & 0 & 1 & 0 \\ 0 & 0 & 0.5 & 0 & 0 & 0.5 & 0 & 1 \\ 1 & 0 & 0.5 & 0.5 & 0.5 & 0 & 0 & 0 \\ 0 & 1 & 0.5 & 0.5 & 0 & 0.5 & 0 & 0\end{matrix} ] \qquad ( 10 )$$

Alternatively, the entries of Rₚᵣᵢₘ can be set to

$${R}_{prim} = [ \begin{matrix}0 & 0 & 0.25 & 0 & 1 & 0 & 1 & 0 \\ 0 & 0 & 0.25 & 0 & 0 & 1 & 0 & 1 \\ 1 & 0 & 0.25 & 0.5 & 0 & 0 & 0 & 0 \\ 0 & 1 & 0.25 & 0.5 & 0 & 0 & 0 & 0\end{matrix} ] \qquad ( 11 )$$

In both examples above, the columns (from left to right) correspond to the channels L, R, C, LFE, Ls, Rs, Lt and Rt, respectively.

The entries of a first secondary matrices R_{sec1}, configured to ignore the two height channels Lt and Rt (columns 7 and 8), can be set to

$${R}_{sec 1} = [ \begin{matrix}0.5 & 0 & 0.25 & 0 & 0.5 & 0 & 0 & 0 \\ 0 & 0.5 & 0.25 & 0 & 0 & 0.5 & 0 & 0 \\ 0.5 & 0 & 0.25 & 0.5 & 0.5 & 0 & 0 & 0 \\ 0 & 0.5 & 0.25 & 0.5 & 0 & 0.5 & 0 & 0\end{matrix} ] \qquad ( 12 )$$

The entries of a second secondary matrix R_{sec2}, configured to ignore the two height channels Lt and Rt (columns 7 and 8) and the two surround channels Ls and Rs (columns 5 and 6), can be set to

$${R}_{sec 2} = [ \begin{matrix}0.707 & 0 & 0 & 0.5 & 0 & 0 & 0 & 0 \\ 0 & 0.707 & 0 & 0.5 & 0 & 0 & 0 & 0 \\ 0 & 0 & 0.5 & 0.5 & 0 & 0 & 0 & 0 \\ 0 & 0 & 0.5 & 0.5 & 0 & 0 & 0 & 0\end{matrix} ] \qquad ( 13 )$$

In another example, a 7.1.2-channel (M=10) input signal is played back by the device in FIG. 3a or 3b (S=4). In this case, the entries of Rₚᵣᵢₘ can be set to

$${R}_{prim} = [ \begin{matrix}0 & 0 & 0.25 & 0 & 0.6 & 0 & 1 & 0 & 0.8 & 0 \\ 0 & 0 & 0.25 & 0 & 0 & 0.6 & 0 & 1 & 0 & 0.8 \\ 1 & 0 & 0.25 & 0.5 & 0.8 & 0 & 0 & 0 & 0.6 & 0 \\ 0 & 1 & 0.25 & 0.5 & 0 & 0.5 & 0 & 0 & 0 & 0.6\end{matrix} ] \qquad ( 14 )$$

In this case, the columns (from left to right) correspond to the channels L, R, C, LFE, Ls, Rs, Lrs, Rrs, Lt and Rt, respectively.

The entries of the secondary matrices R_{sec1} and R_{sec2} can be set to

$${R}_{sec 1} = [ \begin{matrix}0 & 0 & 0.25 & 0 & 0.6 & 0 & 1 & 0 & 0 & 0 \\ 0 & 0 & 0.25 & 0 & 0 & 0.6 & 0 & 1 & 0 & 0 \\ 1 & 0 & 0.25 & 0.5 & 0.8 & 0 & 0 & 0 & 0 & 0 \\ 0 & 1 & 0.25 & 0.5 & 0 & 0.5 & 0 & 0 & 0 & 0\end{matrix} ] \qquad ( 15 )$$

$${R}_{sec 2} = [ \begin{matrix}0 & 0 & 0.5 & 0 & 0.6 & 0 & 0.8 & 0 & 1 & 0 \\ 0 & 0 & 0.5 & 0 & 0 & 0.6 & 0 & 0.8 & 0 & 1 \\ 1 & 0 & 0.5 & 0.5 & 0.8 & 0 & 0.6 & 0 & 0 & 0 \\ 0 & 1 & 0.5 & 0.5 & 0 & 0.8 & 0 & 0.6 & 0 & 0\end{matrix} ] \qquad ( 16 )$$

where R_{sec1} and R_{sec2} correspond to the degenerated 7.1 and 3.1 signal, respectively.

It is noted that the entries of rendering matrices Rₚᵣᵢₘ and R_{secX} can be real constants or frequency dependent complex vectors. For example, the entries of Rₚᵣᵢₘ in equation (2) can be extended to a B-dimensional complex vector, where B is the number of frequency bands. In the aforementioned use case, to enhance the height channels, specific frequency bands can be modified for entries of the last two columns of Rₚᵣᵢₘ in equation (2). An example of the specific frequency bands can be 7 kHz to 9 kHz.

It is also noted, and illustrated by the above examples, that at least some of the entries of the Rₚᵣᵢₘ and R_{secX} matrices may be set to the same.

### Channel Analysis

The channel analysis module 23 aims to determine whether the input signal is degenerated or not, so that the proper pre-rendered signal or an appropriate mixed of them can be used. The module 23 performs on a frame-by-frame basis.

One approach is based on the energy distribution among input channels.

The aforementioned use case, with only two different rendering matrices, can be taken as an example. For the 4-speaker portable device and the 5.1.2 input signal, the gain [symbol] _{raw} is calculated by

$${g}_{r a w} = \{ \begin{matrix}1 , & {r}_{height} \geq {T}_{u} \\ {r}_{height}^{m} , & {T}_{l} \leq {r}_{height} < {T}_{u} \\ 0 & {r}_{height} < {T}_{l}\end{matrix} \qquad ( 17 )$$

where r_{height} is the ratio between the energy of height channels and total energy, m is the power parameter, Tᵤ and Tₗ are the upper bound and lower bound respectively.

In addition to energy, the diffuseness could be an alternative or additional criterion for analyzing the input channels. Large diffuseness tends to assign unbalanced coefficients for L/R channel between top and bottom speakers.

### Adaptive Smoothing and Mixing

The gain [symbol] raw can be further smoothed by the smoothing module 14 according to the history of the input signal. In the current frame n (n>1), the smoothed gain [symbol] _{raw} can be calculated as below

$${g}_{s m} ( n ) = a {g}_{r a w} ( n ) + ( 1 - a ) {g}_{s m} ( n - 1 ) \qquad ( 18 )$$

where α is the smoothing parameter.

The final rendering signal y can be obtained by the mixing process as below

$$y = {g}_{s m} {y}_{p r i m} + ( 1 - {g}_{s m} ) {y}_{sec} \qquad ( 19 )$$

If there are more than two different rendering matrixes, the rendered output will include a mix of three or more pre-rendered signals, depending on the channel analysis.

### Final Remarks

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described specific embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Thus, while there has been described specific embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention. For example, in the illustrated embodiments, the portable device has four speakers (S=4). It is of course possible to have more (or less) than four speakers, which results in different matrix sizes.

1. An audio renderer for rendering a multi-channel audio signal having M channels to a portable device having S independent speakers, wherein S<M, comprising:
a first matrix application module for applying a primary rendering matrix to the input audio signal to provide a first pre-rendered signal suitable for playback on the multiple independent speakers,
a second matrix application module for applying a secondary rendering matrix to the input audio signal to provide a second pre-rendered signal suitable for playback on the multiple independent speakers,
a channel analysis module configured to calculate mixing gain according to a time-varying channel distribution, and
a mixing module configured to produce a rendered output signal by mixing the first and second pre-rendered signals based on the mixing gain.

2. The audio renderer according to claim 1, wherein the secondary rendering matrix is configured to ignore at least one of the channels in the input audio signal.

3. The audio renderer according to claim 2, wherein the input audio signal includes two height channels, and the secondary rendering matrix is configured to ignore said height channels.

4. The audio renderer according to claim 1, wherein the input audio signal is a 5.1.2 audio signal with seven channels (M=7), the number of independent speakers is four (S=4), and wherein the primary rendering matrix is set to:
$${R}_{prim} = [ \begin{matrix}0 & 0 & 0.25 & 0 & 0.5 & 0 & 1 & 0 \\ 0 & 0 & 0.25 & 0 & 0 & 0.5 & 0 & 1 \\ 1 & 0 & 0.25 & 0.5 & 0.5 & 0 & 0 & 0 \\ 0 & 1 & 0.25 & 0.5 & 0 & 0.5 & 0 & 0\end{matrix} ] .$$

5. The audio renderer according to claim 1, wherein the input audio signal is a 5.1.2 audio signal with seven channels (M=7), the number of independent speakers is four (S=4), and wherein the primary rendering matrix is set to:
$${R}_{prim} = [ \begin{matrix}0 & 0 & 0.25 & 0 & 1 & 0 & 1 & 0 \\ 0 & 0 & 0.25 & 0 & 0 & 1 & 0 & 1 \\ 1 & 0 & 0.25 & 0.5 & 0 & 0 & 0 & 0 \\ 0 & 1 & 0.25 & 0.5 & 0 & 0 & 0 & 0\end{matrix} ] .$$

6. The audio renderer according to claim 1, wherein the input audio signal is a 5.1.2 audio signal with seven channels (M=7), the number of independent speakers is four (S=4), and wherein the secondary rendering matrix is set to:
$${R}_{sec} = [ \begin{matrix}0.5 & 0 & 0.25 & 0 & 0.5 & 0 & 0 & 0 \\ 0 & 0.5 & 0.25 & 0 & 0 & 0.5 & 0 & 0 \\ 0.5 & 0 & 0.25 & 0.5 & 0.5 & 0 & 0 & 0 \\ 0 & 0.5 & 0.25 & 0.5 & 0 & 0.5 & 0 & 0\end{matrix} ] .$$

7. The audio renderer according to claim 1, further comprising a smoothing module to smooth a mixing gain for a current frame based on mixing gains for a set of previous frames.

8. The audio renderer according to claim 1, wherein the entries of the primary rendering matrix and the secondary rendering matrix are real constants or frequency dependent complex vectors.

9. The audio renderer according to claim 1, wherein at least some entries of the primary rendering matrix are subdivided in specific frequency bands, e.g. 7 kHz to 9 kHz.

10. The audio renderer according to claim 1, wherein at least some entries of the primary rendering matrix and the secondary rendering matrix are equal.

11. The audio renderer claim 1, wherein the channel analysis module determines the mixing gain based on an energy distribution among the input channels.

12. A method for rendering a multi-channel audio signal having M channels to a portable device having S independent speakers, wherein S<M, comprising:
applying a primary rendering matrix to the input audio signal to provide a first pre-rendered signal suitable for playback on the multiple independent speakers,
applying a secondary rendering matrix to the input audio signal to provide a second pre-rendered signal suitable for playback on the multiple independent speakers,
calculating mixing gain according to a time-varying channel distribution, and
mixing the first and second pre-rendered signals based on the mixing gain to produce a rendered output signal.

13. The method according to claim 12, wherein the secondary rendering matrix is configured to ignore at least one of the channels in the input audio signal.

14. The method according to claim 13, wherein the input audio signal includes two height channels, and the secondary rendering matrix is configured to ignore said height channels.

15. The method according to claim 12, wherein the input audio signal is a 5.1.2 audio signal with seven channels (M=7), the number of independent speakers is four (S=4), and wherein the primary rendering matrix is set to:
$${R}_{prim} = [ \begin{matrix}0 & 0 & 0.25 & 0 & 0.5 & 0 & 1 & 0 \\ 0 & 0 & 0.25 & 0 & 0 & 0.5 & 0 & 1 \\ 1 & 0 & 0.25 & 0.5 & 0.5 & 0 & 0 & 0 \\ 0 & 1 & 0.25 & 0.5 & 0 & 0.5 & 0 & 0\end{matrix} ] .$$

16. The method according to claim 12, wherein the input audio signal is a 5.1.2 audio signal with seven channels (M=7), the number of independent speakers is four (S=4), and wherein the primary rendering matrix is set to:
$${R}_{prim} = [ \begin{matrix}0 & 0 & 0.25 & 0 & 1 & 0 & 1 & 0 \\ 0 & 0 & 0.25 & 0 & 0 & 1 & 0 & 1 \\ 1 & 0 & 0.25 & 0.5 & 0 & 0 & 0 & 0 \\ 0 & 1 & 0.25 & 0.5 & 0 & 0 & 0 & 0\end{matrix} ] .$$

17. The method according to claim 12, wherein the input audio signal is a 5.1.2 audio signal with seven channels (M=7), the number of independent speakers is four (S=4), and wherein the primary rendering matrix is set to:
$${R}_{sec} = [ \begin{matrix}0.5 & 0 & 0.25 & 0 & 0.5 & 0 & 0 & 0 \\ 0 & 0.5 & 0.25 & 0 & 0 & 0.5 & 0 & 0 \\ 0.5 & 0 & 0.25 & 0.5 & 0.5 & 0 & 0 & 0 \\ 0 & 0.5 & 0.25 & 0.5 & 0 & 0.5 & 0 & 0\end{matrix} ] .$$

18. The method according to claim 12, further comprising smoothing a mixing gain for a current frame based on mixing gains for a set of previous frames.

19. A computer program product including computer program code portions configured to perform the steps of claim 12 when executed on a processor.

20. The computer program product according to claim 19, stored on a non-transitory computer-readable medium.
